(19) United States
(12) Patent Application Publication
(10) Pub. No.: US 2014/0005936 A1
(43) Pub. Date: Jan. 2, 2014

(54) INFORMATIONAL, EDUCATIONAL, AND ENTERTAINMENT GPS SYSTEM

(71) Applicant: MARIE ROBICHAUD, HOLDEN, MA (US)

(72) Inventor: MARIE ROBICHAUD, HOLDEN, MA (US)

(21) Appl. No.: 13/854,404

(22) Filed: Apr. 1, 2013

Related U.S. Application Data
(60) Provisional application No. 61/618,766, filed on Mar. 31, 2012.

(51) Int. Cl. G01C 21/00

(52) U.S. Cl. CPC G01C 21/00
USPC 701/468

(57) ABSTRACT

This invention is a hand-held or vehicle-mounted Global Positioning System (GPS) that also includes informational, educational, and entertainment features, especially suited for use by children during vehicle traveling.

### CROSS-REFERENCE TO RELATED APPLICATIONS

This application claims the benefit under 35 U.S.C. §119(e) of U.S. Provisional Application No. 61/618766 filed Mar. 31, 2012, which is hereby incorporated by reference.

### STATEMENT REGARDING FEDERALLY SPONSORED RESEARCH OR DEVELOPMENT

This invention has been created without the sponsorship or funding of any federally sponsored research or development program.

### FIELD OF THE INVENTION

This invention involves a Global Positioning Satellite device (GPS) with additional features that enhance the entertainment and educational benefits of the device.

### BACKGROUND OF THE INVENTION

A GPS device which provides location information while traveling is commonly found installed in passenger vehicles nowadays. The GPS functionality is also available on small handheld digital devices such as the Android Phone, the Iphone, most tablet devices, the Kindle Fire, and other similar personal devices, with display screens of various sizes, color graphics, capable of displaying road maps of most regions of the world. A typical GPS device provides a means for entering a destination point and then the device directs the driver verbally and visually to that destination. Along the way, the GPS device will represent the current position of the vehicle with an icon appropriately situated over a road map displayed on a small display screen.

Prior GPS systems, although very effectively providing location information, are generally limited to that specific function.

These and other difficulties experienced with the prior art devices have been obviated in a novel manner by the present invention.

It is, therefore, an outstanding object of some embodiments of the present invention to provide a GPS system that takes full advantage of the potential entertainment benefits of a modified version of the device.

Another object of some embodiments of the present invention is to provide a GPS system that takes full advantage of the educational benefits of a modified version of the device.

Another object of some embodiments of the present invention is to provide a GPS system that is capable of simple and inexpensive manufacture and has the ability to provide a long and useful life with minimum maintenance.

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF THE INVENTION

This invention is a hand-held or vehicle-mounted Global Positioning System (GPS) that also includes informational, educational, and entertainment features, especially suited for use by children during vehicle traveling.

### BRIEF DESCRIPTION OF THE DRAWINGS

The character of the invention, however, may best be understood by reference to one of its structural forms, as illustrated by the accompanying drawings, in which:

FIG. 1 is shows a plan view of the general features of one embodiment of the present invention.

FIG. 2 is shows a side view of the general features of one embodiment of the present invention.

FIG. 3 is shows a bottom view of the general features of one embodiment of the present invention.

FIG. 4 is shows a bottom view of the inside of, and the back of the upper surface of, one embodiment of the present invention.

### DETAILED DESCRIPTION OF THE INVENTION

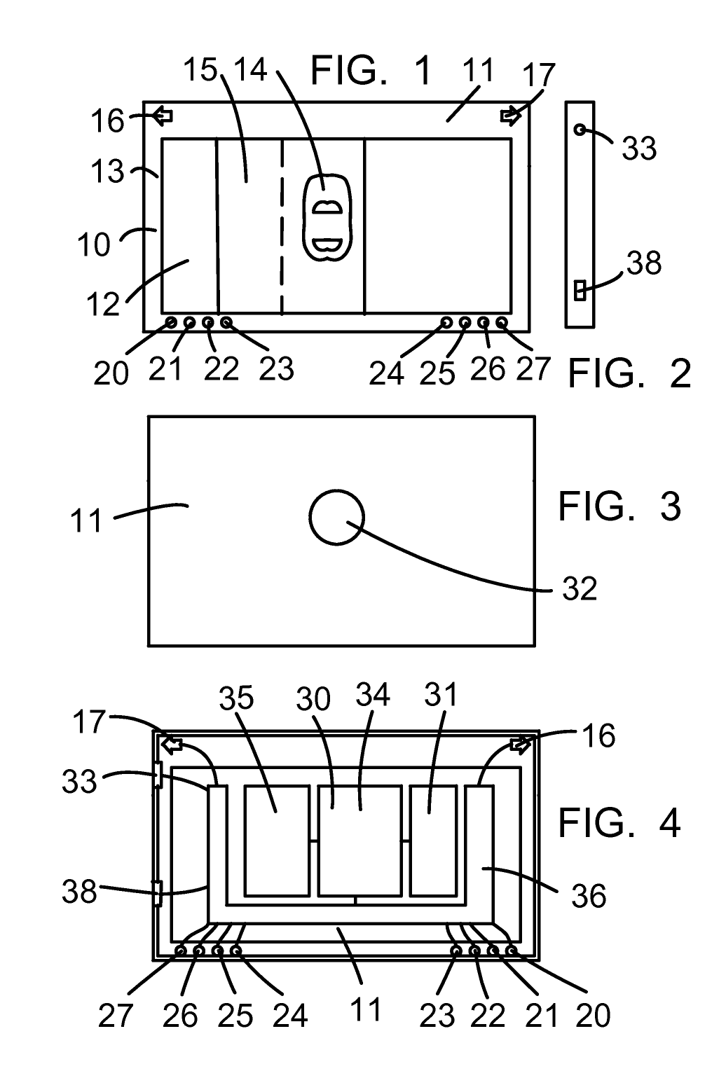

Referring first to FIG. 1 in which the general principles of the present invention are shown, the device, denominated generally by the 10, includes a case 11, and an image presentation screen 12 mounted on the top surface 13 of the case 11. The image presentation screen 12 presents an image of a vehicle 14 and a road 15 on which the vehicle 14 is moving. An illuminatable arrow 16, pointing left, is positioned on the upper left-hand corner of the case 11. An illuminatable arrow 17, pointing right, is positioned on the upper right-hand corner of the case 11. Lined up a long the lower edge of the case 11 are control buttons 20, 21, 22, 23, 24, 25, 26, and 27.

The case 11 contains a digital computer 30 capable of performing both the GPS functions and the additional functions presented as part of this invention. It also contains the communication equipment 31 necessary for the GPS to function. It also contains a speaker 32 and a headphone plug 33 necessary for presenting an audio signal to the user.

The digital computer includes a central processing unit 34, and updatable memory 35. It also includes an interface unit 36 connecting the CPU to the input and output elements, such as the speaker 32, and the communication link 38, such as a USB port, that allows updating of the memory 35.

This type of enhanced GPS device could, with the inclusion of additional features, provide useful content that is informative, educational and entertaining and that would satisfy the various needs of a child traveling on a long trip.

Such a device would be geared towards children and parents, as well as the general needs of travelers, smartphone and smartpad users.

Features which are unavailable on current GPS devices and listed below, would be provided in various combinations in the various embodiments of the present invention.

The device might have child friendly controls, including an appropriate size and shape of the device designed with small children in mind along with age appropriate control methodologies. In one version of the device a microphone could be provided along with appropriate software to allow the device to be operated and its functions controlled by voice commands of the user.

The device might have multiple screens displaying information or games.

The device might be chargeable through the vehicle electrical system.

The device might have multiple voice personalities, in various languages, voices preferably being soft and reassuring in order to be engaging to small children.

The device might be capable of tracking the progress of the trip.

The device might be customizable by the child user.

The device might have a built in camera.

The device might have user selectable personal icons, which locate the vehicle on a displayed road map, the personal icon being an image of a car, a bike, a skateboard or a photo taken using the device itself.

The device might have destination point information displayed, including: an estimated time of arrival and a remaining time, each time estimate related to a particular mode of transportation, for example driving, walking, biking, or skateboarding, and including the ability to compare the times for each mode to another mode.

The device might have the ability to track travel data such as accumulated miles, states visited, or number of items seen, for example: 18 wheelers, buses, or Pa-diddles, including the ability to store accumulated sightings over multiple trips.

The device might have an augmented reality capability, in which the device recognizes notable objects in a photographic image (or live shot) taken with the device and upon the user touching the particular object within the image, the device presents information about that particular object, for example points of interest such as the Washington Monument or the Empire State Building.

The device might have a capability of noting points of interest both educational and entertaining such as playgrounds or libraries in an area.

The device might have a capability of automatically triggering new local points of interest each time a state or regional boundary is crossed, including a pop-up display providing fun facts about the new region. This pop-up display might include that which the region is known for, information about state flags, state birds, state flowers or state census related information or popular local inventions, which can be linked to information about local inventors and including as well historical information for example notable sites of US Civil War battles.

The device might have a capability of recognizing and providing information on local flora and fauna.

The device might have a capability of presenting information on prevalent industries in the area with industry information linked to job openings in the area.

The device might have a capability to display various games.

The device might include a game in which participants look for licence plates from different states.

The device might include a game such as License Plate Bingo in which the device presents all the numbers from 0 through 9 and all the letters from A to Z, randomly assigned to a bingo card displayed on the screen, the user would shake the device in order to re-scramble the displayed card until they are satisfied with the letters and numbers, at which point the letters and numbers on the displayed card are frozen and the bingo game begins.

The device might include a game such as How Many Things Can You Find? For example: school buses, 18 wheelers, bridges, motorcycles, tollbooths or pa-diddles.

The device might include a Word Scramble game which is derived from a particular state's name.

The device might include a game in which each member of the traveling group guess the arrival time from one point to another wherein the various guesses from each member of the group are stored on the device.

The device might include the ability to present elevation, direction and speed information and track minimums, maximums, and averages of that data.

The device might include a conversion calculator capability that allows the user to calculate how long the trip would take, given a particular speed and miles left to travel.

The device might have, particularly with younger children in mind, a capability of representing directionality with either a blinking arrow for left and right or an L and an R symbol properly situated on the display screen to represent those opposing directions.

In summary, a preferred embodiment of this invention is an educational GPS system, preferably used on Android devices. It has a kid friendly design: attractive colors, cheerful music, and simple interfaces allow for it to be easily used by children aged 4-8. It is a kid-friendly GPS, featuring readouts for estimated time of arrival/remaining time via various methods, including car, bicycle, and foot, based on average speeds, path, and distances. It will keep a record of various statistics, including miles traveled, states visited, and elapsed time. It functions as a digital atlas: each state will have a small atlas entry, including a kid-appropriate history, capitol city, state flag, state bird, state flower, and other interesting facts about the state. It provides games: a small catalogue of games, including counting aids for number of various things seen—stop signs, 18-wheeler trucks, state license plates, and more; license plate bingo, memory/matching games featuring state flags, birds, street signs, and more. The target market: the target audience for this invention is primarily children from the ages of 3 or 4 to 8. A secondary factor in determining market base is the parent, as this is targeted just as much for them, as a way to keep children entertained on long car rides and road trips.

It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desire to secure by Letters Patent is:

I claim the invention of:

1. A hand-held or vehicle-mounted Global Positioning System (GPS) that also includes informational, educational, and entertainment features, especially suited for use by children during vehicle traveling.
